(19) United States
(12) Patent Application Publication
(10) Pub. No.: US 2010/0162070 A1
(43) Pub. Date: Jun. 24, 2010

(54) METHOD AND APPARATUS FOR OPTIMIZING A RETRY LIMIT FOR MULTIMEDIA SYSTEMS THAT ARE PRONE TO ERRORS

(75) Inventors: Soumya Das, San Diego, CA (US); Krishnan Rajamani, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/340,249

(22) Filed: Dec. 19, 2008

(51) Int. Cl. H04L 1/18; G06F 11/14

(52) U.S. Cl. 714/751; 714/E11.113

(57) ABSTRACT

Devices, systems and methods for optimizing a number of retransmission attempts in a multimedia environment and managing delays in a host MAC layer. In its various aspects, the presently claimed invention includes several methodologies and systems that are configured for determining an optimal retry limit in response to one or both of a packet error rate bound and a latency bound. To the extent that the retry limit is determined with respect to one of the aforementioned boundaries, the presently claimed invention may include determining a confidence level that the non-selected bound will also be met by the selected retry limit. The presently claimed invention details devices, systems and methods optimizing the number of retransmission attempts to ensure delivery of the selected data packets while guarding against undue delays and application disruptions.

### FIELD

The presently claimed invention relates generally to the field of communications, and more specifically to the field of high-speed communications multimedia environments.

### BACKGROUND

Recent trends in communications have demonstrated that visual content is becoming a more important aspect of both the communications themselves as well as the devices that enable such communications. For example, displays have become much more integral to the operation of mobile phones in recent years. Several systems such as in the mobile display digital interface (MDDI) standard have been adopted by many manufacturers and users as a cost-effective and low-power solution that enables high-speed short-range communication with a display device, for example a display portion of a clamshell-type or flip-phone. These systems typically utilize a miniature connector system and a thin flexible cable for connecting portable computing, communications and entertainment devices to displays, generally referred to as a host and a client, respectively. Although, this disclosure discusses MDDI systems, the disclosure is not limited to these systems and is intended to cover all multimedia systems that are sensitive to latency and prone to errors in the transmission link.

Recent developments in wireless communications have led to the development of multimedia devices, systems and methodologies. In a wired or wireless environment, a host device transmits data packets to one or more client devices, such as displays. The data packets may include various types of media, including for example audio and video data. In a wireless system, there is no physical cabling enabling communication between the host and client, and as such the host may not always be aware of whether or in what manner the client is receiving the wirelessly transmitted data. Typically, a client device will send an acknowledgement message back to the host upon receipt of a packet or stream of packets, thus enabling the host to correctly audit its transmissions and manage its bandwidth.

Due to the inherent physical disconnect between the host and client devices in any multimedia environment, acknowledgement of the receipt of packets is not always transmitted to the host in a timely manner. Typically, a media access control (MAC) layer of the host device will attempt several retransmissions of the packets unless the acknowledgement is received from the client device. In order to preserve valuable bandwidth and the quality of the transmitted data, the MAC layer will typically only retransmit a packet a predetermined number of times before abandoning the packet. In most multimedia systems, the retry limit is set at a predetermined number, which presents two competing problems.

If the retry limit is set too low, then the number of abandoned packets will increase resulting in lower quality data, artifacts and errors in the client device. On the other hand, if the retry limit is set too high, then the MAC layer will continue to consume limited bandwidth and other resources at the host, which in turn will lead to greater delays that might exceed the delay limits of the application, effectively rendering the application inoperable. For example, in a video application it is desirable to have a continuous and relatively instant data stream to ensure continuity of the data at the client. If the MAC layer inadvertently delays the video stream because of excessive retransmissions, then the video application will no longer be able to process the data in order and continuously at the client end.

Accordingly, there is a need in the art for a device, system and method for optimizing a number of retransmission attempts in a multimedia environment.

### SUMMARY

The presently claimed invention includes devices, systems and methods for optimizing a number of retransmission attempts in a multimedia environment and managing delays in a host MAC layer. In one aspect, the presently claimed invention includes a first example method for optimizing a retry limit which includes setting the retry limit in response to one of the latency bound or the packet error rate (PER) bound and step estimating a confidence level for achieving a bound for a nonselected one of the latency bound or the PER bound. The first example method further includes retransmitting the packets in accordance with the retry limit.

A second example method of optimizing a retry limit for retransmitted packets in a MAC layer includes setting a PER bound and setting the retry limit in response to the PER bound. The second example method further includes estimating a confidence level of a latency bound in response to the retry limit and the PER bound, followed by retransmitting the packets in response to the retry limit. In alternative configurations the second example method may further include the step of comparing the confidence level (CL) to a CL threshold value, which may be a predetermined or a value computed and/or weighted in accordance with the relative values of the latency bound and the PER bound.

A third example method includes providing a MAC layer. The MAC layer may include for example a MAC layer operable in a multimedia environment. The third example method includes transmitting packets from a wireless modem to a display, wherein the wireless modem may include a portion of a host device and the display may include a portion of the client device, which in turn may be linked via a protocol of the type described herein. The third example method may also include calculating a retry limit range from a first retry limit derived from a PER bound and a second retry limit derived from a latency bound. The third example method may also include a step reciting that in response to the first retry limit being less than or equal to the second retry limit, retransmitting non-acknowledged data packets; and further in response to the first retry limit being greater than the second retry limit, adjusting one or more transmission parameters. As detailed below, suitable transmission parameters may include a MAC reservation capacity, a MAC fragmentation threshold, an application bit rate, an application frame rate, a physical layer (PHY) rate, and a PHY transmission power.

A fourth example method for selecting an optimal retry limit for a MAC transmission protocol which includes calculating R_p (a target MAC retry limit for satisfying a PER bound) to meet a target residual PER for a given PER. Given R_p, the fourth example method proceeds to determine a value R_d (MAC retransmissions permissible within a delay bound D) to meet the latency bound constraint of the application. The fourth example method further utilizes a determination of a confidence level to ensure a high probability that the retry limit does not exceed the latency bound of the application. If the confidence level is sufficiently high, then the fourth example method includes retransmitting packets in accordance with the target MAC retry limit value.

The methodologies described herein may be incorporated into one or more devices, systems and computer program products. For example, a host device and a client device may be readily configured via any suitable combination of hardware, firmware or software for performing the various functions and processes described in detail below. Further details, configurations and advantages of the presently claimed invention are described in detail below in one or more exemplary aspects with reference to the following figures.

### BRIEF DESCRIPTION OF THE DRAWINGS

FIG. 1 is a schematic block diagram of a system for optimizing a MAC retry limit in a multimedia environment in accordance with one aspect of the presently claimed invention.

FIG. 2 is a schematic block diagram of a system hierarchy in a multimedia environment in accordance with one aspect of the presently claimed invention.

FIG. 3 is a flowchart depicting a method for retransmitting packets in a multimedia environment in accordance with one aspect of the presently claimed invention.

FIG. 4 is a flowchart depicting another method for retransmitting packets in a multimedia environment in accordance with one aspect of the presently claimed invention.

FIG. 5 is a flowchart depicting a method for controlling a MAC retransmission protocol in a multimedia environment in accordance with one aspect of the presently claimed invention.

FIG. 6 is a flowchart depicting a method for selecting an optimal retry limit for a MAC transmission protocol in a multimedia environment in accordance with one aspect of the presently claimed invention.

FIG. 7 is a schematic timeline illustrating a MAC transmission sequence in a multimedia environment in accordance with one aspect of the presently claimed invention.

FIG. 8 is a flowchart depicting a method for controlling a MAC retransmission protocol in a multimedia environment in accordance with one aspect of the presently claimed invention.

FIG. 9 is a flowchart depicting another method for controlling a MAC retransmission protocol in a multimedia environment in accordance with one aspect of the presently claimed invention.

### DETAILED DESCRIPTION

The presently claimed invention is described herein with reference to selected features and aspects thereof with reference to the appended figures. It should be understood by those of skill in the art of communications that the foregoing descriptions are exemplary in nature only, and that the scope of the presently claimed invention is defined by the following claims.

The following detailed description is applicable to all source coding schemes including both reserved bandwidth schemes and contention access schemes. While some of the following discussion relates specifically to exemplary aspects that apply to reserved bandwidth schemes, the general principles of the presently claimed invention apply to various protocols including, but not limited to Distributed Reservation Protocol (DRP), Prioritized Contention Access (PCA), Hybrid Coordination Function (HCF), HCF Controlled Coordination Access (HCCA) and Enhanced Distributed Channel Access (EDCA). For an exemplary reserved bandwidth scheme, the methodologies described herein are derived from the parameters set forth in the following table. Further, the presently claimed invention may be implemented in any multimedia system that is prone to latency errors in the transmission of multimedia traffic, and includes but is not limited to MDDI systems, IP video transmission systems and wireless video systems.

| | |
|---|---|
| MSDU | MAC service data units |
| M | Number of MSDUs per video frame |
| R | MAC retry limit |
| p | Packet or Frame error rate of MSDU |
| D | Available margin of delay bound for application |
| p_{R} | Target residual packet error rate |
| R_{D} | MAC retransmissions available within delay bound D |
| R_{P} | MAC retry limit for satisfying p_{R} |
| p_{delay} | Packet error rate of MSDU to exceed delay bound |
| p_{d} | Video frame error probability |
| N_{avg} | Average number of transmissions for a single |
| | MSDU |
| T | Transmission time per MSDU |
| T_{avg} | Average time to transmit a video frame |
| CLₜₕᵣₑₛₕ | Lower bound for CL not to exceed delay bound |
| V_{R} | Video bit rate |
| C | MAC capacity |
| F | Video frame rate, per second |
| n | Sample size for CL estimates of delay not |
| | exceeding D |

For purposes of the present application, a video frame is in error if any of the M MSDUs comprising the video frame is in error. Mathematically the potential error may be represented as:

p_{d}=1−(1−p^{R+1})^{M}. (1)

A first order approximation of Equation (1) yields,

p_{d}=(p^{R+1})×M. (2)

Given a large sample:

$${N}_{avg} = \frac{1 - {p}^{R + 1}}{1 - p} , \qquad ( 3 )$$

Then it follows that:

$${T}_{avg} = {N}_{avg} \times M \times T = ( \frac{1 - {p}^{R + 1}}{1 - p} ) \times M \times T . \qquad ( 4 )$$

In order to satisfy the latency (delay) bound the following condition applies:

$${R}_{D} + 1 \leq \frac{D}{T \times M} . \qquad ( 5 a )$$

This worst case corresponds to the case when all M MSDUs within one video frame have to undergo R_{D} retransmissions. Equation (5a) may be rewritten as:

$${R}_{D} \leq \frac{D}{T \times M} - 1 \qquad ( 5 b )$$

In order to have the residual frame error rate less than or equal to the target error rate, p_{d}≦p_{R} it follows from the approximation of equation (2) that p^{R}^{ₚ}⁺¹×M≦p_{R}, which may be rewritten as:

$${R}_{p} \geq \frac{ln ( \frac{{p}_{R}}{M} )}{ln ( p )} - 1 \qquad ( 6 a )$$

Given the foregoing, it is possible to have value for the retry limit that simultaneously satisfies both the latency bound and residual PER bound. This value for R is possible when the following conditions apply:

$$R \leq \frac{D}{T \times M} - 1 and R \geq \frac{ln ( \frac{{p}_{R}}{M} )}{ln ( p )} - 1 \qquad ( 6 b )$$

The following table shows the values of Rₚ (assuming M=100 and P_{R}=10e−6) for some values of PER.

| PER | R_{P} |
|---|---|
| 0.01 | 3 |
| 0.05 | 6 |
| 0.10 | 7 |
| 0.15 | 9 |
| 0.20 | 11 |

Assuming R_{D}=4, it is apparent that there is an overlap for p=0.01, but not for higher values of p. For high values of p, it might be possible to satisfy either the latency bound or the PER bound, but in a mutually exclusive fashion. In that case, to get back to an operating region where both bounds are satisfied, it may be possible to adjust one or more transmission parameters of the device and/or system. For example, a reduction of the bit rate with compression and/or reduced frame rate/resolution along with PHY rate to decrease PER and hence Rₚ might satisfy both the latency bound and the PER bound. Alternatively, an increase in the MAC capacity would increase R_{D}, which in turn might satisfy both the latency bound and the PER bound for a given operating region.

Another example methodology includes selecting the initial MAC retry limit as the number of retries needed to satisfy a target PER. The target PER bound is selected as the effect of the residual frame error rate on the subjective video quality is assumed to be more pronounced than the delay; however, other aspects may involve selecting the initial MAC retry limit as it pertains to the latency bound, depending upon the application and/or operating conditions.

The selected MAC retry limit might or might not satisfy the conditions of the latency bound. Accordingly, the aspects of the presently claimed invention estimate the CL of the delay due to MAC retransmissions not exceeding the latency bound. If the CL is above a threshold (e.g., a value close to 100% such as 95%), the retry limit is selected as the optimal MAC retry limit. On the other hand, if the CL is less than the threshold, then a number of recovery mechanisms need to be considered in order to get back to a satisfactory operating region, including at least adjusting one or more transmission parameters of the system and/or device(s).

One aspect of the methodologies described herein find an operating region with the CL of the delay due to R for meeting p_{R} not exceeding D being greater than or equal to CLₜₕᵣₑₛₕ. The CL is estimated assuming a Gaussian error probability distribution. As noted above, the models and methodologies described herein apply to contention free access protocols. It is valid for DRP option of WiMedia MAC and HCCA option of 802.11 MAC. The concepts described herein apply also to the PCA option of WiMedia MAC and EDCA option of 802.11 MAC.

Assuming that bandwidth allocation corresponds to the desired video frame rate plus the nominal retransmission budget, one may determine that:

N_{avg}×V_{R}=C (7)

For one unit of time, the systems and devices are adapted to transmit F video frames, which in turn is M×F MSDUs and N_{avg}×M×F MAC transmissions. Accordingly, it is the case that:

$$T = \frac{1}{{N}_{avg} \times M \times F} , and \\ {T}_{avg} = {N}_{avg} \times M \times T = \frac{1}{F} \qquad ( 8 )$$

For example, if F is 30 frames per second, then T_{avg} equals 33.33 milliseconds.

Equations 3, 5, and 8 may be combined to yield:

$$\begin{matrix}{R}_{D} \leq \frac{D}{T \times M} - 1 = D \times {N}_{avg} \times F - 1 \\ = \frac{DF ( 1 - {p}^{R + 1} )}{1 - p} - 1 \leq \frac{DF}{1 - p} - 1\end{matrix} \\ {R}_{D} \leq \frac{DF}{1 - p} - 1 \qquad ( 9 )$$

The system and/or device would exceed the latency bound if within the duration D, R>R_{D}, e.g., there are more than R_{D}+1 MAC transmissions on average for each of M MSDUs corresponding to 1 video frame in the observation window. Therefore, the latency bound will be met as long as

$${\sum }_{i = 1}^{M} {R}_{i} \leq {R}_{D} M$$

where Rᵢ is the number of MAC retransmissions for the ith MSDU. That is, in order to exceed the delay margin, the PER given by:

$$\frac{{\sum }_{i = 1}^{M} {R}_{i}}{{\sum }_{i = 1}^{M} ( {R}_{i} + 1 )} > \frac{{R}_{D} M}{( {R}_{D} + 1 ) M} = \frac{{R}_{D}}{{R}_{D} + 1} \\ {p}_{delay} > \frac{{R}_{D}}{{R}_{D} + 1} \qquad ( 10 )$$

For a sample size defined by:

(n)=(R_{D}+1)×M. (11)

The combination of equations 9 and 10 yields:

$${p}_{delay} > \frac{{R}_{D}}{{R}_{D} + 1} ≅ \frac{\frac{DF}{1 - p} - 1}{\frac{DF}{1 - p}} = \frac{DF - 1 + p}{DF} \qquad ( 12 )$$

The foregoing assumes that R_{D} is constant for all values of p. However, in the event that the bandwidth allocation is corresponding to nominal retransmission budget; bandwidth needs to scale at the rate

$$\frac{1 - {p}^{R + 1}}{1 - p}$$

or approximately

$$\frac{1}{1 - p}$$

times, resulting in a higher value of R_{D} shown in equation (13).

$${R}_{D , scaled} = \frac{{R}_{D} + 1}{1 - p} - 1 = \frac{{R}_{D} + p}{1 - p} \qquad ( 13 )$$

This scaled value of R_{D} may be used in the methodologies described herein instead of R_{D} for potentially greater accuracy in the computations and estimates.

As an example of the CL estimation may be described given a set of operation conditions such as: F=30 fps, M=100, D=167 ms, and p_{R}=10e−6. Using the foregoing equations, one may readily determine that T_{avg}=33.33 ms, R_{D}=4, n=500, and p_{delay}≧0.8. The nominal PER (p) may be thought to be the long term average PER. Thus, if we are operating under a PER (p)=0.1, we may tolerate error in PER estimation up to (p_{delay}−p) e.g. 0.8-0.1=0.7. Equation (4) provides a model of correlating sample size, error and confidence interval. If the sample mean is used as an estimate of the population mean, then one will be (1−α)100% confident that the error will be less than a specific amount e for a given sample size n. Accordingly:

$${e}^{2} \geq {( {Z}_{α / 2} σ )}^{2} \frac{1}{n} , \qquad ( 14 )$$

where Z_{α/2} is the value of the standard normal distribution having an area of α/2 to the right, n is the sample size, and σ is the population standard deviation. It follows that,

$${z}_{α / 2}^{2} \leq \frac{{e}^{2} n}{{σ}^{2}} \qquad ( 15 )$$

If as an example the bandwidth allocation is increased X times the nominal bandwidth requirement corresponding to operating PER, then the number of permissible retransmissions without exceeding delay margin increases. That is,

R_{D}_{_{—}}_{New}=X(R_{D}_{_{—}}_{Old}+1)−1 (16)

Sample size over the observation interval (e.g. delay margin) increases as R_{D} increases:

n_{New}=(R_{D}_{_{—}}_{New}+1)M=X(R_{D}_{_{—}}_{Old}+1)M=Xn_{old}. (17)

The probability of error to exceed the latency margin p_{delay} increases as R_{D} increases. With increase in p_{delay}, error (e) and hence Z_{α/2} increases, thereby increasing the CL for not exceeding D. The implication is that adjustment of one or more transmission parameters, such as increasing MAC capacity or increasing compression factor without reducing MAC capacity, may return the system and/or device into an optimal operating region.

In another example it might be the case that M (due to compression) and bandwidth allocation have been reduced X times. As a result, of this, the number of permissible retransmissions without exceeding delay margin remains the same.

R_{D}_{_{—}}_{New}=R_{D}_{_{—}}_{Old} (18)

Sample size over the observation interval (e.g., delay margin) reduces X times as M decreases, or:

$$\begin{matrix}{n}_{New} = ( {R}_{D\_New} + 1 ) {M}_{New} \\ = ( {R}_{D\_Old} + 1 ) {M}_{New} \\ = ( {R}_{D\_Old} + 1 ) {M}_{Old} \frac{1}{X} \\ = \frac{{n}_{Old}}{X}\end{matrix} \qquad ( 19 )$$

The probability of error to exceed delay bound p_{delay} remains substantially the same. With p_{delay} remaining unchanged, the error (e) also remains substantially the same. Since as the sample size reduces, Z_{α/2} decreases, the CL for not exceeding D is also reduced. As such, the implication is that increasing the compression factor and reducing the MAC capacity at same time tends to worsen the operations of the device and/or system. In response to the foregoing, the methodologies described herein include adjusting one or more transmission parameters in order to ensure optimized operation. In particular, when the operating region is not satisfying both the residual error rate and the delay constraints or if the CL of not exceeding the delay margin is not above the predetermined threshold, then increased compression along with fragmentation without reducing bandwidth allocation may return the system and/or device to optimal operations.

The presently claimed invention includes various methodologies for estimating the CL. One example method is configured to estimate the CL based alone or in part on equation (15) above. This example method for estimating the CL assumes that it is possible to estimate the population standard deviation with 100% confidence with a very large sample size. Further assumptions for this example method include: (1) the estimating CL of not exceeding delay margin is equivalent to estimating CL of PER not exceeding a threshold; (2) the PER follows a Gaussian distribution; (3) knowledge of the population standard deviation with 100% confidence is possible; (4) the MAC capacity is scaled with the nominal retransmission budget; (5) the sample size during the observation interval, e.g., the delay margin, is (R_{D}+1)*M; and (6) there is no requirement on minimum sample size and method may be applicable for uncompressed as well as compressed video and/or data packets.

A second method of estimating the CL is applicable in cases when σ is unknown or it is unlikely that to know the standard deviation of a population, the mean of which it is desirable to estimate. If population standard deviation is unknown, then referring to equation (4), which is applicable to a binomial random variable with a given probability of success; which in the example case is 1−p. Assuming the foregoing applies, then the standard deviation (under the constraint that n>5/p) is given by:

σ²=p(1−p) (20)

Therefore, equation (14) becomes:

$${e}^{2} \geq ( {Z}_{α / 2}^{2} p ( 1 - p ) ) \frac{1}{n} = > {Z}_{α / 2}^{2} \leq \frac{{e}^{2} n}{p ( 1 - p )} \qquad ( 21 )$$

At the extreme tails of the distribution, equation (20) becomes invalid and the following lower bound may be imposed:

$$n \geq \frac{5}{p} \qquad ( 22 )$$

There is some correlation between the CL of not exceeding the latency bound and the CL of PER not exceeding

$$\frac{{R}_{D}}{{R}_{D} + 1} .$$

However, it is also true that the CL of not exceeding the delay bound is the CL of PER being less than

$$\frac{{R}_{D}}{{R}_{D} + 1}$$

or being more than Pₘₐₓ where Pₘₐₓ corresponds to the PER for the MAC retry limit to achieve the residual target PER. For example, if R=8 for residual PER, then Pₘₐₓ=8/9=0.89.

The second example method for estimating the CL relies on distinct mathematical and operational assumptions, such as: (1) estimating the CL of not exceeding the delay margin is substantially equivalent to estimating the CL of the PER not exceeding a threshold; (2) the PER follows Gaussian distribution; (3) the appropriate model is a binomial random variable with a given probability of success e.g. (1−p) to estimate the standard deviation; (4) MAC capacity is assumed to scale with the nominal retransmission budget; (5) the sample size during the observation interval or delay margin is (R_{D}+1)*M; and (6) that the sample size needs to be at least the minimum as given in equation (22).

If the number of samples is less than the minimum desired samples, which may be likely to happen for low values of PER for compressed video, then the CL of not exceeding the delay margin may not be estimated directly. Instead the CL for those values of PER has to be lower bounded with the CL corresponding to higher values of PER for which the sample size requirement is met. Alternatively, the second example method allows for fragmentation of compressed video as there is no need to send 4 KB MSDUs, which in turn will reduce the PER and also increase the sample size over the observation interval.

If the population standard deviation maynot be estimated with one hundred percent confidence, then the first example method for estimating the CL may not be optimal. If the sample size requirements are not met, then the second example method for estimating the CL may also not be optimal. As such, the presently claimed invention includes a third example method for estimating the CL. The third example method assumes the knowledge of the PER distribution (mean and standard deviation) for the operating EbNo value across different channel realizations with a high confidence perhaps less than one hundred percent. That is, the third example method assumes the value of the standard deviation and then models its estimate of a sample CL over multiple cycles to reach a statistically accurate estimate of a virtual CL.

For example, the third example method may employ 500 of the most common channel realizations for a given scenario, and a PER of each of the channel realizations may be obtained from simulations, mathematical models or experiments. The standard deviation of the PER of different channel realizations is entirely due to variations across channels.

Given the foregoing, the third example method includes a first step of for the given value of delay margin D, calculate p_{delay} from equation (10). Alternatively, the scaled R_{d} from equation (13) may be used for calculating p_{delay}. The third example method may also include a second step of determining the percentage of channel realizations (Y) for which PER≦p_{delay} from the PER distribution across channel realizations. The value Y in turn represents the percentile of channel realizations for p_{delay}. The third example method may be used in scenarios having a large number of channels in which systems run the application, from which is may be determined that in Y percent of the channels the systems would not exceed the delay margin. The third example method may be used at least if the channel changes over time in the same geographical location or if the geographical location changes over time mimicking different channel realizations over time.

The third example method of estimating the CL through the creation of a virtual CL relies on its own partially distinct set of mathematical and operational assumptions, including: (1) that estimating the CL of not exceeding delay bound is substantially equivalent to estimating the CL of the PER not exceeding a threshold; (2) that knowledge of the PER across different channel realizations is representative for a given scenario; (3) that the sample size is independent of the observation interval and there is no requirement on a minimum sample size; (4) that the percentile of channel realizations having a PER less than a predetermined threshold is an estimate of the CL of not exceeding the delay margin; and (5) that the method is applicable for uncompressed and compressed video and/or data for all values of the PER assuming that the PER distribution for a large number of sample realizations corresponds to the operating EbNo or PER.

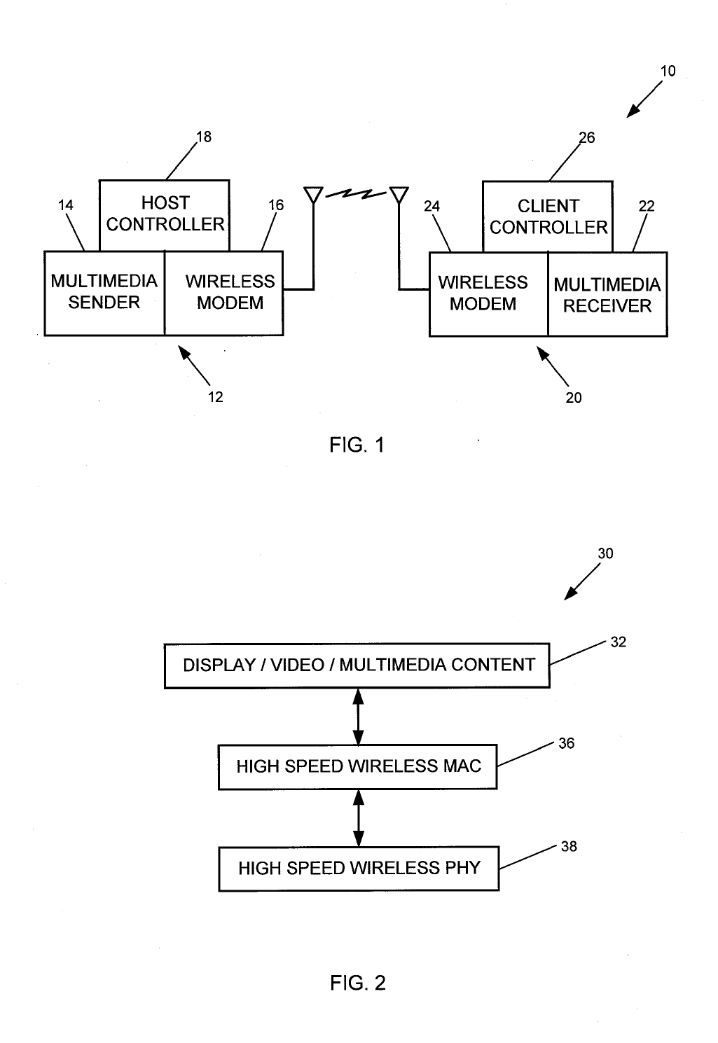

Each of these example methods for estimating the CL is described in more detail below in the context of various exemplary aspects of the devices, systems and methods of the presently claimed invention. As shown in FIG. 1, a system 10 for optimizing a retry limit in a multimedia environment in accordance with one aspect of the presently claimed invention includes a host device 12 that is wirelessly connectable to a client device 20. Host device 12 may include a sender module 14 and a wireless modem 16, each of which is connectable to a host controller 18 adapted to control at least the communications functions of host device 12, including at least those functions described in greater detail below with reference to FIGS. 2 through 9. Host controller 18 may include for example any suitable combination of hardware, firmware, or software that is adapted to control the communications functions of host device 12. Similarly, client device 12 may include a receiver module 22 and a wireless modem 24, each of which is connectable to a client controller 26 adapted to control at least the communications functions of client device 20. Client controller 26 may also include for example any suitable combination of hardware, firmware, or software that is adapted control the communications functions of client device 20, including at least those functions described in greater detail below with reference to FIGS. 2 through 8.

Each of host device 12 and client device 20 may have a functional system hierarchy 30, one aspect of which is shown in FIG. 2. System hierarchy 30 may include for example display/video/multimedia content 32 that is layered on top of a high-speed wireless MAC layer 36, which in turn may run on top of a high-speed wireless PHY layer 38.

In operation, host device 12 transmits packets to client device 20, which in turn acknowledges receipt of the transmitted packets with an acknowledgement message, either I-ACK or B-ACK. In some circumstances, client device 20 will not transmit an acknowledgement message if its frame check sequence (FCS) computation fails. The MAC of host device 12 will continue to retransmit packets until one of two conditions is met: 1) client device 20 acknowledges receipt of the packets, or 2) a number of MAC retransmissions reaches a MAC retry limit (R), in which case the MAC of host device 12 abandons the retransmission efforts for that packet. The retry limit R may be a predetermined number that, in accordance with the aspects of the presently claimed invention, may be optimized to ensure efficient and seamless communications in systems 10 of the type described herein. As described more fully herein, an optimal estimate of the retry limit R is desirable as a low value of R will result in prematurely abandoned retransmissions while a high value of R will result in transmission delays to client device 20.

For a firmware and/or software implementation of aspects of the presently claimed invention, the systems and/or methodologies may be implemented with modules (e.g., procedures, functions, and so on) that perform the functions described herein. Any machine-readable medium tangibly embodying instructions may be used in implementing the methodologies described herein. For example, software codes may be stored in a memory, such as the memory associated with one of host device 12 or client device 20, and executed by the respective controllers 18, 26. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

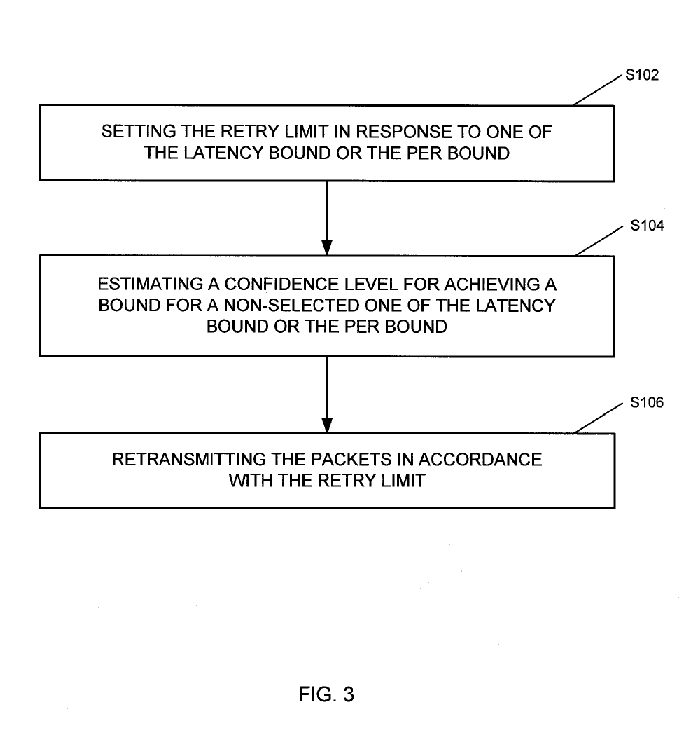

The presently claimed invention also includes a method of optimizing a retry limit for retransmitted packets in a MAC layer. As described in more detail below, the MAC layer may include a latency bound and a PER bound for any suitable application. As shown in FIG. 3, the example method includes step S102, which recites setting the retry limit in response to one of the latency bound or the PER bound and step S104, which recites estimating a confidence level for achieving a bound for a nonselected one of the latency bound or the PER bound. That is, if the device computes a retry limit based on the latency bound, e.g. to ensure that any retransmissions do not cause undue delays in the communications, then the example method directs the device to calculate and/or estimate a confidence level or probability that the established retry limit will be less than or equal to the PER bound, which is not explicitly calculated. By way of example, if a device sets a retry limit of six in response to the latency bound, then the example method further requires estimating a probability or CL that the retry limit of six would comply with the PER bound. If the CL is relatively high, then there is little chance that the retry limit will adversely affect the error rate of the communications due to retransmission of the packets. Conversely, if the CL is relatively low, then there is a greater chance that continued retransmission may adversely affect the quality of the received data. The example method further includes step S106, which recites retransmitting the packets in accordance with the retry limit.

In one variation of the example method, the method may further include the step of comparing the CL to a CL threshold, which may be either a predetermined value or a value computed and/or weighted in accordance with the relative values of the latency bound and the PER bound. Additionally, the example method may include the steps of computing an aggregate latency across one or more preceding application frames and comparing the aggregate latency to an aggregate latency threshold value. In another variation of the example method, the method may include the step of adjusting one or more transmission parameters in response to one of the confidence level decreasing below the CL threshold value or the aggregate latency exceeding the aggregate latency threshold value. Suitable transmission parameters include, but are not limited to a MAC reservation capacity, a MAC fragmentation threshold, an application bit rate, an application frame rate, a PHY rate and a PHY transmission power.

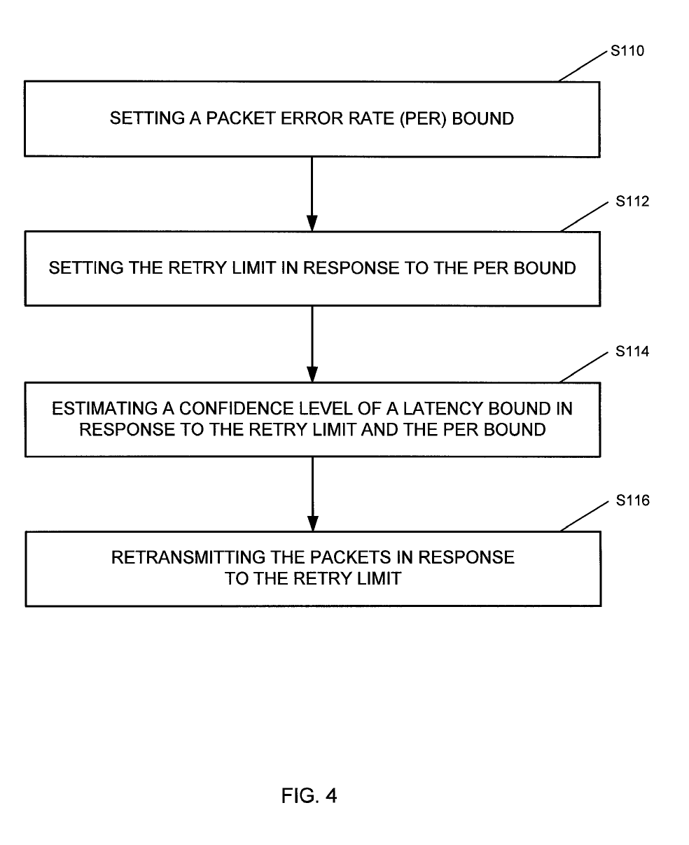

FIG. 4 is a flowchart depicting another example method of optimizing a retry limit for retransmitted packets in a MAC layer. In step S110, the example method recites setting a PER bound in accordance with the methodologies described above. Step S112 recites setting the retry limit in response to the PER bound, and step S114, recites estimating a confidence level of a latency bound in response to the retry limit and the PER bound. In step S116, the example method recites retransmitting the packets in response to the retry limit. As noted above, in alternative configurations the example method may further include the step of comparing the confidence level to a CL threshold value, which may be a predetermined or a value computed and/or weighted in accordance with the relative values of the latency bound and the PER bound.

In another variation, the example method may include the steps of computing an aggregate latency across one or more preceding application frames and comparing the aggregate latency to an aggregate latency threshold value. In response to one of the CL decreasing below the CL threshold value or the aggregate latency exceeding the aggregate latency threshold value, the example method may include the step of adjusting one or more transmission parameters. As noted above, suitable transmission parameters may include a MAC reservation capacity, a MAC fragmentation threshold, an application bit rate, an application frame rate, a PHY rate and a PHY transmission power.

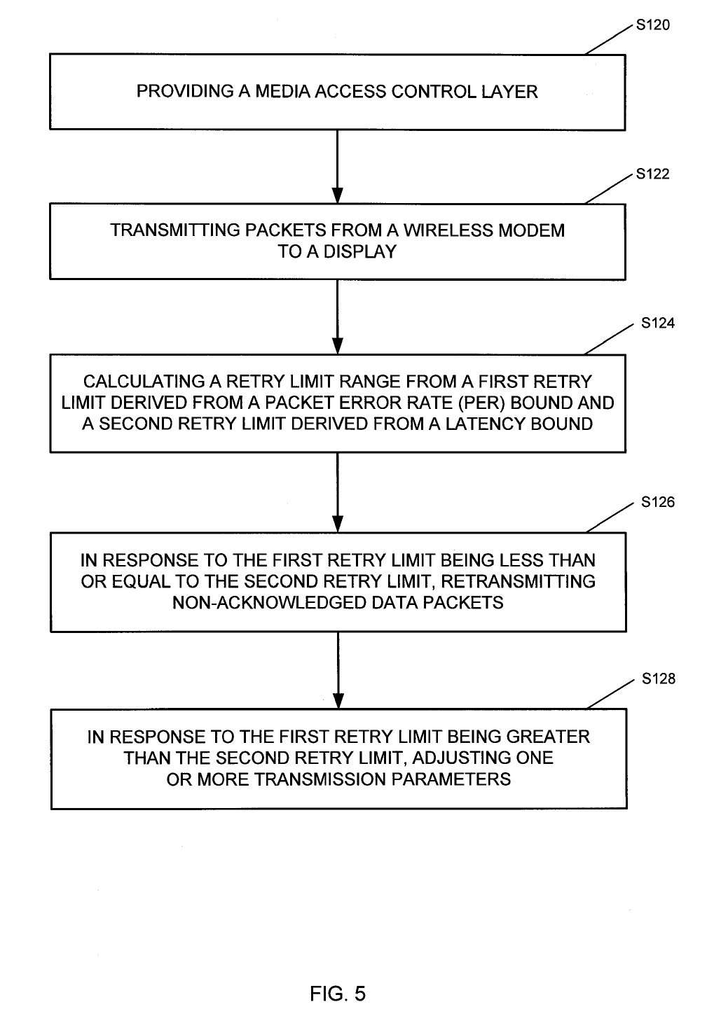

Another aspect of the presently claimed invention is depicted in the flowchart of FIG. 5, which in step S120 recites providing a MAC layer. The MAC layer may include for example a MAC layer of the type described with reference to FIG. 2, and operable in a system and/or apparatus of the type described with reference to FIG. 1. In step S122, the example method recites transmitting packets from a wireless modem to a display. Referring again to FIG. 1, the wireless modem may include a portion of the host device 12 and the display may include a portion of the client device 20, which in turn may be linked via a multimedia protocol of the type described herein. In step S124, the example method recites calculating a retry limit range from a first retry limit derived from a PER bound and a second retry limit derived from a latency bound. In step S126, the example method recites in response to the first retry limit being less than or equal to the second retry limit, retransmitting non-acknowledged data packets; and step S128 recites in response to the first retry limit being greater than the second retry limit, adjusting one or more transmission parameters.

For example, if the first retry limit (derived from the PER bound) is six and the second retry limit (derived from the latency bound) is seven, then the example method directs the device/apparatus to continue retransmission of the packets as the retransmission itself should not cause undue delays in the communications. On the contrary, if the first retry limit is seven and the second retry limit is six, then retransmission up to R=7 would likely cause delays in the communications, in which case the method directs the device/apparatus to adjust one or more transmission parameters. As noted above, suitable transmission parameters may include a MAC reservation capacity, a MAC fragmentation threshold, an application bit rate, an application frame rate, a PHY rate and a PHY transmission power.

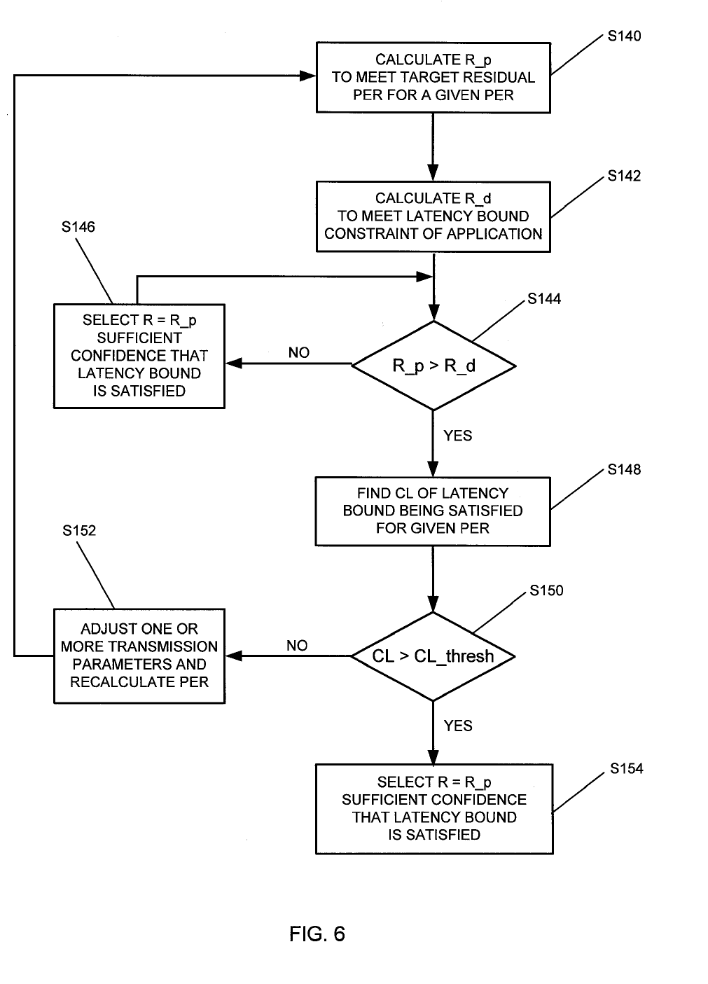

FIG. 6 is a flowchart depicting another example method for selecting an optimal retry limit for a MAC transmission protocol in a multimedia environment in accordance with another aspect of the presently claimed invention. As shown in step S140, the example method recites calculating R_p (a target MAC retry limit for satisfying a PER bound) to meet a target residual PER for a given PER. Given R_p, the example method proceeds to step S142 in which a value R_d (MAC retransmissions permissible within a delay bound D) is calculated to meet the latency bound constraint of the application, which may vary between applications and between times or periods of any single application. In step S144, the example method queries whether R_p is greater than R_d, that is, whether the PER-based retry limit exceeds the latency-based retry limit. If the response to query S144 is negative, then the example method proceeds to step S146 in which the value R_p is selected with sufficient confidence that the latency bound would also be satisfied. If the response to query S144 is affirmative, then the example method proceeds to step S148 which recites finding or computing a CL of the latency bound being satisfied for the given PER.

In step S150, the example method queries whether the computed CL is greater than a threshold value, CL_thresh. As noted above, the threshold value may be predetermined for select applications or it may be dynamically altered, computed, adapted or revised depending upon the application or any specific time period or aspect of the application. If the response to query S150 is negative, then the example method proceeds to step S152, which recites adjusting one or more transmission parameters and recalculating the PER, after which the example method returns to step S140 to begin the aforementioned steps again. If the response to query S150 is affirmative, then the device is assured of a sufficient probability of its retransmissions not causing undue delays in the communications. Accordingly, the example method proceeds to step S154 in which the retry limit R is set equal to R_p having sufficient confidence that the latency bound is also satisfied.

Delays caused by packet retransmissions are only one portion of the total delays incurred during communications in a system 10 of the type described herein. For a particular application requiring video streaming, the overall application delay D_{T} may range between 150 to 250 milliseconds. Aside from the retransmission delays, potential delays may include a MAC access latency, encoding and decoding delays, and software processing delays. Each of these delays may be denoted D_{R} and amount to a total delay in the range of approximately 25-40 milliseconds. Additionally, transmission delays may occur when the time of the video frame (e.g. M MSDU's corresponding to the video frame) exceeds an average value T_{avg} because of packet errors. All of these aggregate delays may affect the available delay margin D for each subsequent video frame.

For example, assuming an application delay D_{T} of 200 milliseconds and application delays D_{R} of 33 milliseconds, then the total remaining delay budget available is 167 milliseconds. For a budgeted delay margin denoted as D_{A} determined by the multimedia layer, it is apparent that the total delay budget is the difference between 167 milliseconds and the delay margin D_{A}. In operation, the multimedia layer monitors cumulative delays across video frames and takes corrective action whenever the cumulative delay exceeds the delay margin D_{A}. The value D_{A} may be predetermined based on application type, or varied dynamically in response to feedback and operating conditions. The difference between D_{A} and 167 milliseconds is D, the total delay budget for any particular frame.

The systems and methodologies described herein determine a CL for not exceeding the delay budget D over any predetermined observation window, which may include for example a single video frame resulting in a relatively conservative estimate of the CL. Accordingly, for the two values D and D_{A}, the systems and methodologies described herein are configured for taking prospective corrective action in response to the sum of these two values exceeding the total available delay period, e.g. 167 milliseconds. This feature avoids the multimedia layer being reactive to delayed and/or error-prone transmissions in favor of being proactive and minimizing operating errors and/or inefficiencies in the multimedia communications.

The methodologies described herein may be applied across a variety of platforms and standards. For example, if the EDCA option of 802.11 MAC or the PCA option of WiMedia MAC is utilized, then the average transmission time of a video frame depends on the contention window for the MSDU transmissions. In that instance, the additional latency may be included as a distinct EDCA margin for the purpose of the delay budgeting described herein or integrated into the existing delay margins defined above by refining the margin values accordingly.

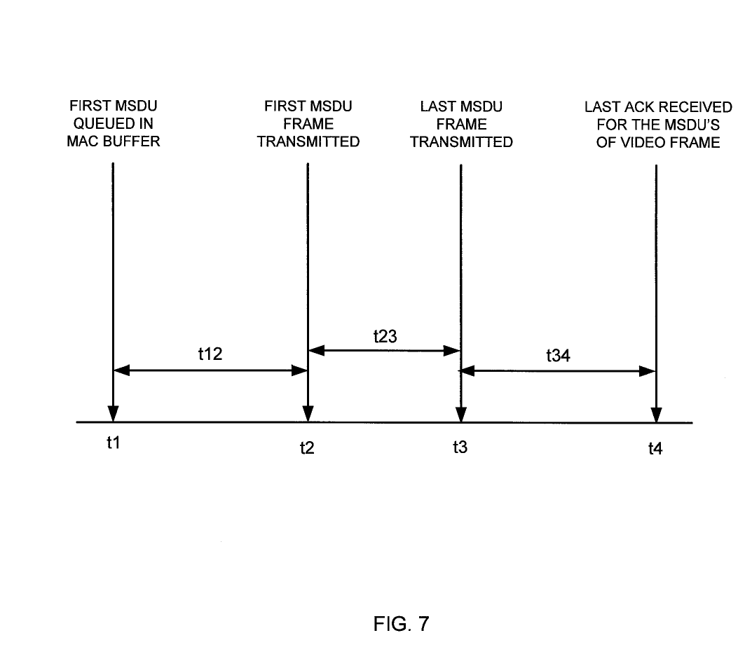

Other aspects of the delay budgeting aspect of the presently claimed invention are shown in FIGS. 7 through 9. FIG. 7 illustrates a timeline of MSDU transmissions for one video frame. As shown, time t1 represents an arbitrary time when the multimedia protocol layer gives the first MSDU of the current video frame and it is queued in the MAC buffer for transmission. Time t2 is the time when the first MSDU of the video frame is transmitted, and time t3 is the time when the last MSDU of the video frame is transmitted. Time t4 is the time when the last ACK for all of the transmitted MSDUs is received by host device 12. In the instance that the I-ACK is utilized, then the time t4 may be accurately measured. If, on the other hand, the B-ACK is utilized then the B-ACK window may not span MSDUs of multiple video frames. As such, in the case of B-ACK protocols, the last MSDU of each video frame may also include a BACKBoundry flag set in the MAC data request primitive.

As shown in FIG. 7, the interval t12 represents the queuing delay due to retransmissions of MSDUs of previous video frames and hence represents the aggregate delay across video frames up to the immediately preceding video frame. Interval t23 represents the queuing delay due to the retransmissions of previous MSDUs of the current video frame. Lastly, the sum of intervals t23 and t34 represents the delay for MAC transmissions for the MSDUs for the current video frame. The multimedia layer may determine time t1 as the time at which the first MSDU is transmitted to the MAC and time t4 as the time at which the MAC confirms receipt to the multimedia layer. Times t2 and t3 are typically not known at the multimedia layer. Given times t1 and t4, the multimedia layer may calculate an aggregate delay D_{aggregate} as the interval between t4 and t1 less the average time to transmit a video frame T_{avg}. If the bandwidth reservation corresponding to a nominal PER is sufficient then queuing delays would not be expected to be significant. On the other hand, if the bandwidth reservation is not sufficient, then the queuing delays would begin building up and eventually D_{aggregate} will eventually exceed the margin D_{A}.

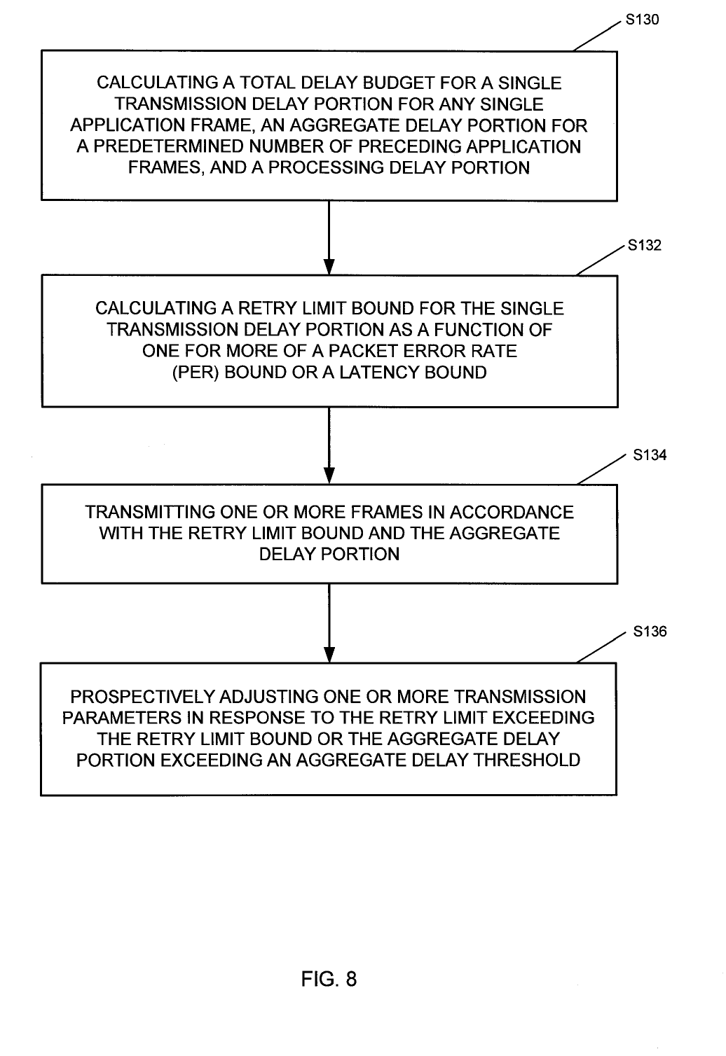

A first example method for monitoring the aggregate delays across video frames is shown in FIG. 8. As shown, in step S130 the example method recites calculating a total delay budget for a single transmission delay portion for any single application frame, an aggregate delay portion for a predetermined number of preceding application frames, and a processing delay portion as described above. In step S132, the example method recites calculating a retry limit bound for the single transmission delay portion as a function of one or more of a PER bound or a latency bound. In step S134, the example method recites transmitting one or more frames in accordance with the retry limit bound and the aggregate delay portion. As noted above, it is preferable to adjust transmission parameters before any delays cause adverse effect to the communications. As such, step S136 recites prospectively adjusting one or more transmission parameters in response the retry limit exceeding the retry limit bound or the aggregate delay portion exceeding an aggregate delay threshold.

In one variation of the example method the step of calculating a retry limit bound includes setting the retry limit in response to one of the latency bound or the PER bound, estimating a CL for achieving a bound for a nonselected one of the latency bound or the PER bound, and retransmitting the packets in accordance with the retry limit. Alternatively, the step of calculating a retry limit bound may include setting a PER bound, setting the retry limit in response to the PER bound, estimating a CL of a latency bound in response to the retry limit and the PER bound, and retransmitting the packets in response to the retry limit as described above. In yet another variation of the example embodiment, the step of calculating a retry limit bound includes calculating a retry limit range from a first retry limit derived from a PER bound and a second retry limit derived from latency bound. As noted above, suitable transmission parameters may include at least a MAC reservation capacity, a MAC fragmentation threshold, an application bit rate, an application frame rate, a PHY rate and a PHY transmission power.

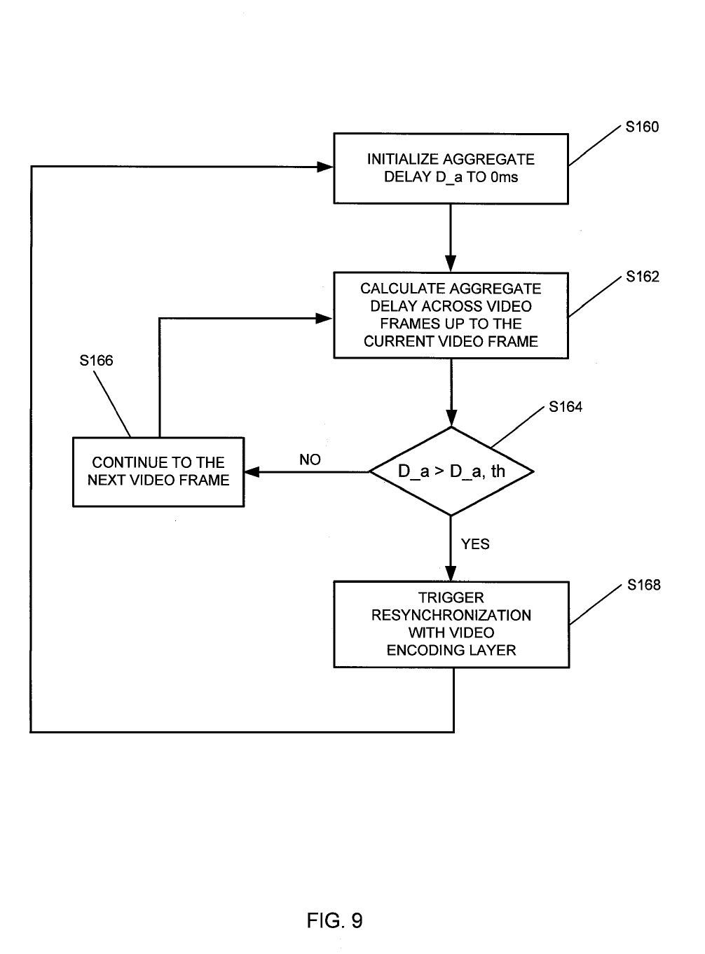

Another example method for monitoring the aggregate delay across video frames is shown in FIG. 9. In step S160, the example method initializes the aggregate delay to zero milliseconds. In step S162, the example method recites calculating the aggregate delay across one or more video frames up to the current video frame. In step S164, the example method queries whether the aggregate delay exceeds a predetermined aggregate delay threshold. If the response to query S164 is negative, then the example method proceeds to step S166 in which case the method proceeds back to step S162 and recalculates the aggregate delay. If the response to query S164 is affirmative, then the method proceeds to step S168 which recites triggering a resynchronization of the multimedia layer with the video encoding layer, after which the example method returns to step S160 an begins the aforementioned process again.

The preceding descriptions are related to selected aspects and examples of the systems and methods of the presently claimed invention. It should be understood by those of skill in the art that these descriptions are exemplary in nature, and that the full scope and import of the presently claimed invention is defined with reference to the following claims.

What is claimed is:

1. A method of optimizing a retry limit for retransmitted packets in a medium access control (MAC) layer defining a latency bound and a packet error rate (PER) bound for an application, the method comprising the steps of:
setting the retry limit in response to one of the latency bound or the PER bound;
estimating a confidence level for achieving a bound for a nonselected one of the latency bound or the PER bound; and
retransmitting the packets in accordance with the retry limit.

2. The method of claim 1, further comprising the step comparing the confidence level to a CL threshold value.

3. The method of claim 2, further comprising the steps of computing an aggregate latency across one or more preceding application frames and comparing the aggregate latency to an aggregate latency threshold value.

4. The method of claim 3, further comprising the step of adjusting one or more transmission parameters in response to one of the confidence level decreasing below the CL threshold value or the aggregate latency exceeding the aggregate latency threshold value.

5. The method of claim 4, wherein the one or more transmission parameters comprise: a MAC reservation capacity, a MAC fragmentation threshold, an application bit rate, an application frame rate, a PHY rate and a PHY transmission power.

6. A method of optimizing a retry limit for retransmitted packets in a medium access control (MAC) layer, the method comprising the steps of:
setting a packet error rate (PER) bound;
setting the retry limit in response to the PER bound;
estimating a confidence level of a latency bound in response to the retry limit and the PER bound; and
retransmitting the packets in response to the retry limit and the confidence level.

7. The method of claim 6, further comprising the step of comparing the confidence level to a CL threshold value.

8. The method of claim 7, further comprising the steps of computing an aggregate latency across one or more preceding application frames and comparing the aggregate latency to an aggregate latency threshold value.

9. The method of claim 8, further comprising the step of adjusting one or more transmission parameters in response to one of the confidence level decreasing below the CL threshold value or the aggregate latency exceeding the aggregate latency threshold value.

10. The method of claim 9, wherein the one or more transmission parameters comprise: a MAC reservation capacity, a MAC fragmentation threshold, an application bit rate, an application frame rate, a PHY rate and a PHY transmission power.

11. A method of optimizing the retry limit for retransmitted packets in a wireless communications system, the method comprising the steps of:
providing a media access control layer;
transmitting data packets from a wireless modem to a display;
calculating a retry limit range from a first retry limit derived from a packet error rate (PER) bound and a second retry limit derived from a latency bound;
in response to the first retry limit being less than or equal to the second retry limit, retransmitting non-acknowledged data packets; and
in response to the first retry limit being greater than the second retry limit, adjusting one or more transmission parameters.

12. The method of claim 11, wherein the one or transmission parameters comprise: a MAC reservation capacity, a MAC fragmentation threshold, an application bit rate, an application frame rate, a PHY rate and a PHY transmission power.

13. A method of partitioning a total delay budget for MAC transmissions comprising:
calculating a total delay budget for a single transmission delay portion for any single application frame, an aggregate delay portion for a predetermined number of preceding application frames, and a processing delay portion;
calculating a retry limit bound for the single transmission delay portion as a function of one or more of a packet error rate (PER) bound or a latency bound;
transmitting one or more frames in accordance with the retry limit bound and the aggregate delay portion; and
prospectively adjusting one or more transmission parameters in response the retry limit exceeding the retry limit bound or the aggregate delay portion exceeding an aggregate delay threshold.

14. The method of claim 13, wherein the step of calculating a retry limit bound comprises setting the retry limit in response to one of the latency bound or the PER bound, estimating a confidence level for achieving a bound for a nonselected one of the latency bound or the PER bound, and retransmitting the packets in accordance with the retry limit.

15. The method of claim 13, wherein the step of calculating a retry limit bound comprises setting a packet error rate (PER) bound, setting the retry limit in response to the PER bound, estimating a confidence level of a latency bound in response to the retry limit and the PER bound, and retransmitting the packets in response to the retry limit.

16. The method of claim 13, wherein the step of calculating a retry limit bound comprises calculating a retry limit range from a first retry limit derived from a packet error rate (PER) bound and a second retry limit derived from latency bound.

17. The method of claim 13, wherein the one or more transmission parameters comprise: a MAC reservation capacity, a MAC fragmentation threshold, an application bit rate, an application frame rate, a PHY rate and a PHY transmission power.

18. A storage media comprising program instructions which are computer-executable to implement optimization of a retry limit for retransmitted packets in a medium access control (MAC) layer defining a latency bound and a packet error rate (PER) bound for an application, the storage media comprising: program instructions that cause a retry limit to be set in response to one of the latency bound or the PER bound;
program instructions that cause a confidence level to be estimated for achieving a bound for a nonselected one of the latency bound or the PER bound; and
program instructions that cause the packets to be retransmitted in accordance with the retry limit.

19. The storage media of claim 18, further comprising program instructions to compare the confidence level to a CL threshold value.

20. The storage media of claim 19, further comprising program instructions to compute an aggregate latency across one or more preceding application frames and compare the aggregate latency to an aggregate latency threshold value

21. The storage media of claim 20, further comprising program instructions to adjust one or more transmission parameters in response to one of the confidence level decreasing below the CL threshold value or the aggregate latency exceeding the aggregate latency threshold value.

22. The storage media of claim 21, wherein the one or more transmission parameters comprise: a MAC reservation capacity, a MAC fragmentation threshold, an application bit rate, an application frame rate, a PHY rate and a PHY transmission power.

23. A storage media comprising program instructions which are computer-executable to implement optimization of a retry limit for retransmitted packets in a medium access control (MAC) layer, the storage media comprising:
program instructions to set a packet error rate (PER) bound;
program instructions to set the retry limit in response to the PER bound;
program instructions to estimate a confidence level of a latency bound in response to the retry limit and the PER bound; and
program instructions to retransmit the packets in response to the retry limit and the confidence level.

24. The storage media of claim 23, further comprising program instructions to compare the confidence level to a CL threshold value.

25. The storage media of claim 24, further comprising program instructions to compute an aggregate latency across a predetermined number of frames and compare the aggregate latency to an aggregate latency threshold value.

26. The storage media of claim 24, further comprising program instructions to adjust one or more transmission parameters in response to one of the confidence level decreasing below the CL threshold value or the aggregate latency exceeding the aggregate latency threshold value.

27. The storage media of claim 26, wherein the one or more transmission parameters comprise: a MAC reservation capacity, a MAC fragmentation threshold, an application bit rate, an application frame rate, a PHY rate and a PHY transmission power.

28. A storage media comprising program instructions which are computer-executable to implement an optimization of a retry limit for retransmitted packets in a wireless communications system, the storage media comprising:
program instructions comprising a provision of a media access control layer;
program instructions to transmit data packets from a wireless modem to a display;
program instructions to calculate a retry limit range from a first retry limit derived from a packet error rate (PER) bound and a second retry limit derived from a latency bound;
program instructions to retransmit non-acknowledged data packets in response to the first retry limit being less than or equal to the second retry limit and adjust one or more transmission parameters in response to the first retry limit being greater than the second retry limit; and
program instructions to adjust one or more transmission parameters in response to the first retry limit being greater than the second retry limit.

29. The storage media of claim 28, wherein the one or more transmission parameters comprise: a MAC reservation capacity, a MAC fragmentation threshold, an application bit rate, an application frame rate, a PHY rate and a PHY transmission power.

30. A storage media comprising program instructions which are computer-executable to implement partitioning a total delay budget for MAC transmissions, the storage media comprising:
program instructions to calculate a total delay budget for a single transmission delay portion for any single application frame, an aggregate delay portion for a predetermined number of preceding application frames, and a processing delay portion;
program instructions to calculate a retry limit bound for the single transmission delay portion as a function of one or more of a packet error rate (PER) bound or a latency bound;
program instructions to transmit one or more frames in accordance with the retry limit bound and the aggregate delay portion; and
program instructions to prospectively adjust one or more transmission parameters in response the retry limit exceeding the retry limit bound the aggregate delay portion exceeding an aggregate delay threshold.

31. The storage media of claim 30, wherein the program instructions to calculate a retry limit bound comprises program instructions to set the retry limit in response to one of the latency bound or the PER bound, program instructions to estimate a confidence level for achieving a bound for a nonselected one of the latency bound or the PER bound, and program instructions to retransmit the packets in accordance with the retry limit.

32. The storage media of claim 30, wherein the program instructions to calculate a retry limit bound comprises program instructions to set a packet error rate (PER) bound, program instructions to set the retry limit in response to the PER bound, program instructions to estimate a confidence level of a latency bound in response to the retry limit and the PER bound, and program instructions to retransmit the packets in response to the retry limit.

33. The storage media of claim 30, wherein the program instructions to calculate a retry limit bound comprises program instructions to calculate a retry limit range from a first retry limit derived from a packet error rate (PER) bound and a second retry limit derived from a latency bound.

34. The storage media of claim 30, wherein the one or more transmission parameters comprise: a MAC reservation capacity, a MAC fragmentation threshold, an application bit rate, an application frame rate, a PHY rate and a PHY transmission power.

35. An apparatus operable with a medium access control (MAC) layer, the apparatus comprising:
a wireless modem adapted to transmit a wireless signal comprising a plurality of packets to a display; and
a controller connected to the wireless modem, the controller adapted to set a retry limit in response to one of a latency bound or a PER bound; estimate a confidence level for achieving a bound for a nonselected one of the latency bound or the PER bound; and retransmit the packets in accordance with the retry limit.

36. The apparatus of claim 35, wherein the controller is further adapted to compare the confidence level to a CL threshold value.

37. The apparatus of claim 36, wherein the controller is further adapted to compute an aggregate latency across a predetermined number of application frames and compare the aggregate latency to an aggregate latency threshold value.

38. The apparatus of claim 37, wherein the controller is further adapted to adjust one or more transmission parameters in response to one of the confidence level decreasing below the CL threshold value or the aggregate latency exceeding the aggregate latency threshold value.

39. The apparatus of claim 38, wherein the one or more transmission parameters comprise: a MAC reservation capacity, a MAC fragmentation threshold, an application bit rate, an application frame rate, a PHY rate and a PHY transmission power.

40. An apparatus operable with a medium access control (MAC) layer, the apparatus comprising:
a wireless modem adapted to transmit a wireless signal comprising a plurality of packets to a display; and
a controller connected to the wireless modem, the controller adapted to set a packet error rate (PER) bound, set a retry limit in response to the PER bound, estimate a confidence level of a latency bound in response to the retry limit and the PER bound, and retransmit the packets in response to the retry limit and the confidence level.

41. The apparatus of claim 40, wherein the controller is further adapted to compare the confidence level to a CL threshold value.

42. The apparatus of claim 41, wherein the controller is further adapted to compute an aggregate latency across a predetermined number of application frames and compare the aggregate latency to an aggregate latency threshold value.

43. The apparatus of claim 42, wherein the controller is further adapted to adjust one or more transmission parameters in response to one of the confidence level decreasing below the CL threshold value or the aggregate latency exceeding the aggregate latency threshold value.

44. The apparatus of claim 43, wherein the one or more transmission parameters comprise: a MAC reservation capacity, a MAC fragmentation threshold, an application bit rate, an application frame rate, a PHY rate and a PHY transmission power.

45. A system for optimizing a retry limit for retransmitted packets in a wireless communications network, the system comprising:
a wireless modem configured for operation with a media access control layer and adapted to transmit data packets to a display in accordance with one or more transmission parameters; and
a controller connected to the wireless modem and adapted to calculate a retry limit range from a first retry limit derived from a packet error rate (PER) bound and a second retry limit derived from latency bound; wherein, in response to the first retry limit being less than or equal to the second retry limit, the controller is adapted to retransmit non-acknowledged data packets; and in response to the first retry limit being greater than the second retry limit, the controller is adapted to adjust one or more transmission parameters.

46. The system of claim 45, wherein the one or more transmission parameters comprise: a MAC reservation capacity, a MAC fragmentation threshold, an application bit rate, an application frame rate, a PHY rate and a PHY transmission power.

47. A controller configured for partitioning a total delay budget for MAC transmissions comprising:
means for calculating a total delay budget for a single transmission delay portion for any single application frame, an aggregate delay portion for a predetermined number of preceding application frames, and a processing delay portion;
means for calculating a retry limit bound for the single transmission delay portion as a function of one or more of a packet error rate (PER) bound or a latency bound;
means for transmitting one or more frames in accordance with the retry limit bound and the aggregate delay portion; and
means for prospectively adjusting one or more transmission parameters in response the retry limit exceeding the retry limit bound the aggregate delay portion exceeding an aggregate delay threshold.

48. The controller of claim 47, wherein the means for calculating a retry limit bound comprises means for setting the retry limit in response to one of the latency bound or the PER bound, means for estimating a confidence level for achieving a bound for a nonselected one of the latency bound or the PER bound, and means for retransmitting the packets in accordance with the retry limit.

49. The controller of claim 47, wherein the means for calculating a retry limit bound comprises means for setting a packet error rate (PER) bound, means for setting the retry limit in response to the PER bound, means for estimating a confidence level of a latency bound in response to the retry limit and the PER bound, and means for retransmitting the packets in response to the retry limit.

50. The controller of claim 47, wherein the means for calculating a retry limit bound comprises means for calculating a retry limit range from a first retry limit derived from a packet error rate (PER) bound and a second retry limit derived from latency bound.

51. The controller of claim 47, wherein the one or more transmission parameters comprise: a MAC reservation capacity, a MAC fragmentation threshold, an application bit rate, an application frame rate, a PHY rate and a PHY transmission power.
